(19) United States
(12) Patent Application Publication
(10) Pub. No.: US 2022/0061206 A1
(43) Pub. Date: Mar. 3, 2022

(54) Auto Grow Zoysia Germinators

(71) Applicant: John Jerome Gironda, Clifton Park, NY (US)

(72) Inventor: John Jerome Gironda, Clifton Park, NY (US)

(21) Appl. No.: 17/462,771

(22) Filed: Aug. 31, 2021

Related U.S. Application Data
(60) Provisional application No. 63/073,131, filed on Sep. 1, 2020.
(60) Provisional application No. 63/077,631, filed on Sep. 13, 2020.
(60) Provisional application No. 63/174,570, filed on Apr. 14, 2021.

(51) Int. Cl. A01C 1/02; A01G 13/02

(52) U.S. Cl. CPC A01C 1/02; A01G 13/0268

(57) ABSTRACT

Auto Grow Zoysia Germinators are sealed planting containers that provide warm, moist growing conditions for set it and forget it zoysia seed germination. Planting containers are assembled with topsoil and seed, then covered with plastic, gray landscape fabric and sealer material.

### BACKGROUND OF INVENTION

Zoysia grass is naturally drought and weed resistant and therefore reduces the need of weed control chemicals while also conserving water. When managed properly, zoysia can also reduce lawn chemical requirements for grub control.

Auto Grow Zoysia Germinators are designed for establishing Zoysia lawns in the northern planting zones. The methods described herein are pointed towards Zenith/Japonica Zoysia grass seed germination but can be used for germinating other seed types. Simply substitute the soil specifications, germination and seedling requirements for your seed type.

Zoysia is one of the higher touch grasses to germinate. Unlike cool season grasses that can germinate in less than 1 week under a variety of weather conditions, zoysia germination can take significantly longer and requires warm, moist soil conditions. Missed watering's or cooler temperatures can reduce zoysia seed germination success rates. If the soil is allowed to dry out some or all of the seeds can die and we are back to square one, or worse, since previously invested time and money cannot be recovered.

Auto Grow Zoysia Germinators are covered and sealed to allow self-germination and removes the need for repeated watering. The sealed coverings provide a warm, moist growing medium for seed germination.

Current methods of establishing zoysia lawns include plugs or sod. The provider must germinate the zoysia seedlings, allow for seedling maturation, then deliver to the buyer. Sod is expensive and plugs require a high level of effort. With plugs, given their relatively small size, a high number of small installation holes are recommended by providers, hence the high level of effort.

Additionally, plugs and sod must be removed from their original growing medium and then replanted at their permanent lawn site. This causes transplant shock which could slow establishment.

Since Auto Grow Zoysia Germinators germinate at their permanent lawn site, transplant shock does not occur.

Also, Auto Grow Zoysia Germinators allows the user to select the size of the zoysia plug. With the In-Ground Container option, the size of the plug can be 4 inches round or 2+feet round. With the In-Ground Tiller options, the size of the plug can be multiple square feet in size, from an average size of 6 square feet to 20 square feet and larger.

### SUMMARY OF INVENTION

Auto Grow Zoysia Germinators are assembled using one of the following planting container methods:
1. Biodegradable Planting Pots—Used to germinate and grow seedlings directly in the existing lawn using biodegradable planting pots.
2. In-Ground Container—No planting container needed. Seedlings germinate and grow directly in ground, using the ground as the container.
3. Tiller Planter—A rototiller is used to create large in-ground containers for larger seeding applications.
4. Planting Pots—Used to germinate seedlings for future transplanting. It is important to note that this optional method will cause transplant shock.

The above methods use the same assembly process which is filling the planting container with properly moistened quality top soil, applying the seed, ensuring good seed to soil contact, then covering and sealing the planting container with clear plastic and gray landscape fabric.

### BRIEF DESCRIPTION OF THE DRAWINGS

FIG. 1 shows the side view of the zoysia germinator planting container with overhanging fabric.

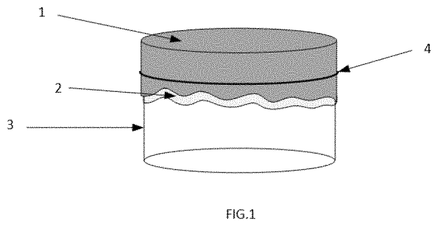

FIG. 2 shows the tamping method used to pre-settle the soil at the center of the planting container to prevent pooling of water.

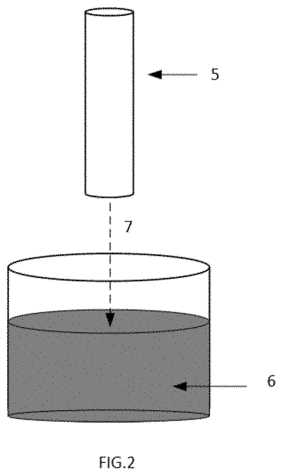

FIG. 3 shows the top view of the zoysia germinator planting container with ‘cut to fit’ fabric.

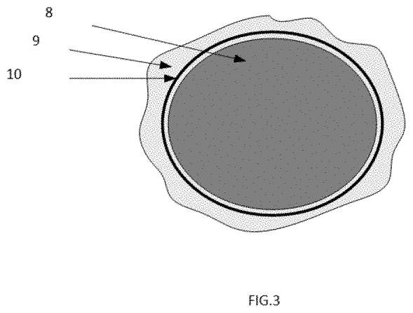

FIG. 4 shows the perspective view of the in-ground zoysia germinating planting container.

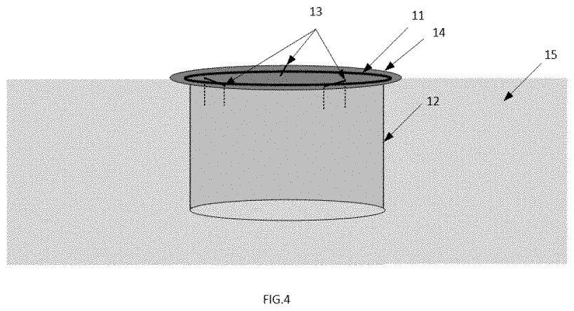

FIG. 5 shows the top view of the zoysia germinator tiller planter.

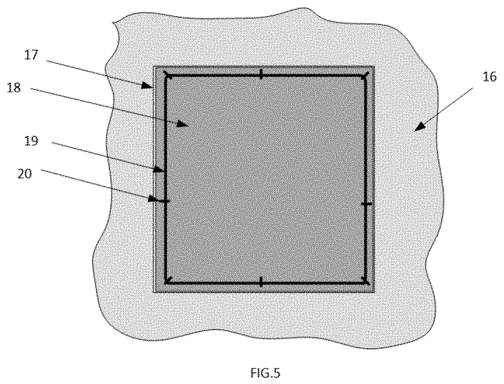

### DETAILED DESCRIPTION OF THE INVENTION

Auto Grow Zoysia Germinators should be assembled in the spring when weather conditions are warm enough for seed germination. The guideline is for soil temperatures to reach approximately 60 degrees.

For planting in mid to late summer, Auto Grow Zoysia Germinators should be assembled when there is sufficient time for seedlings to mature and survive the winter. The guideline is for germination to take place 60 days before the average first frost. Auto Grow Zoysia Germinators can be used to extend the growing season and will be discussed in this specification.

### Biodegradable Planting Pots

This auto grow zoysia germinator is assembled in biodegradable planting pots that are installed directly in the ground at the lawn site. The seed will germinate in-ground where the roots are pre-acclimated to their surroundings. The planter pots will compost in to the existing soil so there is no need to remove the planter pot. Zoysia roots are vigorous and will not have trouble growing through the biodegradable material. Peat moss pots will work well but are not required. Any biodegradable material that will naturally compost in to the soil can be used.

Items needed:
Biodegradable round planting pots
Quality topsoil with pH range of 6.0-6.5
Gray landscape fabric
Clear plastic (˜1 ml)
Rubber band, sized to seal fabric and plastic around planting pot
Quality Zenith or Japonica Zoysia seed
Hose with mist and shower setting
Dry topsoil (optional)
Existing lawn soil with good moisture content. Dry lawn soil will make digging difficult and will cause the germination topsoil to dry out which will compromise success rate. If necessary, deep water the lawn prior to installing the auto grow zoysia germinators.
Healthy existing lawn and soil. The lawn should not have bugs, especially grubs, as they will compromise success rates. The lawn should also not have fungus or moss issues. The lawn should have a neutral to slightly acidic pH with proper NPK nutrients. Proper lawn soil is important for all types of lawn seeding efforts.

Steps:

1. Check the moisture content of the topsoil to be used to fill the planting pots. The moisture level of the topsoil is important so that sufficient moisture is available for seed germination. However, do not over saturate the soil. The soil should not be muddy. The soil can clump when squeezed, but should not clump on its own. The topsoil should not contain wood chips, stones, pebbles or other debris. The seeds should have a clean growing medium so they do not need to push through debris when germinating.

2. Cut the landscape fabric 1 and plastic 2 so that both will hang half way down the side of the planting pot. The overhang is important for biodegradable planters so that the soil in the planting pot does not dry out after installation in the ground.

3. Fill the planting pots 3 approximately ⅔ with topsoil.

4. Using a cylinder or dowel 5, tamp down the soil 6 in the center of the planting pot using motion 7. One tamp is all that is required. The idea is to pre-settle soil at the center of the container so that there is not a depression in the center after settling.

5. Fill the remainder of the planting pot with topsoil. A slight crown to the soil is preferred, but minimally, ensure the soil is level with no depressions. Water should not pool in the soil, either with initial planting or post germination.

6. Mist the surface of the topsoil.

7. Add seed as per its recommended rate to the topsoil in the planting pot. Spray seeds with a light mist of water or liquid fertilizer (3-1-2 ratio or similar).

8. At this point in the process, there are two options for ensuring good seed/soil contact. One option is to apply light pressure to the plastic that covers the seeds. The 2nd option is to lightly cover the seeds with dry topsoil, and then give the dry topsoil a good mist. If dry topsoil sprinkling is chosen, skip step 10.

9. Cover the planting pot with the clear plastic.

10. Apply light pressure to the plastic to provide good contact of the seed to the soil.

11. Cover the plastic with the gray landscape fabric. Ensure the plastic and fabric over hang approximately halfway down the planting pot.

12. Attach rubber band 4 to the overhanging plastic and fabric. The rubber band should be snug to seal in the soil moisture but should not be overly tight where it begins to crush the planting pot. The rubber band should be near the top of the planting pot, so it can be retrieved and removed after seed germination. Attaching the rubber band approximately 1 inch below the planting pot is a good rule of thumb.

13. Using an auger or shovel, dig one hole for each planting pot. Make the depth of the hole approximately the same height of the topsoil in the planting pot. The width of the holes should be slightly larger in diameter than the planting pot. When inserting the planting pot in the hole, the planting pot topsoil must be slightly higher than the surrounding soil. The planting pot soil must not settle lower than the surrounding soil or water will pool on the seedlings. This could compromise success rate.

14. Fill in soil around the planting pot. Use a spray of water to settle the excavated soil to original ground level.

15. The Auto Grow Zoysia Germinators should not be stepped on or ridden over with lawn mower tires. Install the auto grow zoysia germinators in particular patterns so that lawn mowing can be easily accomplished without the lawn mower wheels running over the planters. The spacing between the planting pots will depend on lawn mower width and user preference.

16. After approximately 10 days, check for germination by slightly removing one side of the plastic and fabric. Slightly remove the rubber band to accomplish this. Germination depends on weather conditions. The seeds will germinate faster during sunny day periods as compared with cloudy periods.

17. After the seedlings are approximately 1/2 inch high, remove the rubber band, plastic and fabric. Give the seedlings a deep watering with liquid fertilizer (3-1-2 ratio or similar). Water the seedlings once per day in the morning, or more frequently during especially hot and dry weather conditions. The planting pot can be used as a gauge to determine the amount of water needed. As the soil in the planting pot begins to lose moisture during the day, the soil will not expand against the planting pot as much or start to slightly pull away from the sides of the pot. When this occurs, water the seedlings until water can be seen rising to the top of the planting pot. A garden hose with its nozzle set on the shower setting is a good watering method. Water so that the soil remains moist but not overly wet or muddy. Do not let the soil dry out.

18. The gray landscape fabric can be optionally reinstalled over the planting pot. Reinstalling the landscape fabric will help keep the seedlings moist and will reduce watering needs. Spray the landscape fabric to keep the soil moist. Watering frequency depends on weather conditions. Watering once in the morning is a good guideline. Two watering's per day might be needed in especially hot and dry conditions. With watering or rainfall, the water will drip through the fabric down to the seedlings. Another advantage of reinstalling the gray landscape fabric is if the planting pots are installed later in the summer season when 60 days of seedling establishment is cutting it close. The landscape fabric will protect the seedlings from frost. It is not recommended to keep the reinstalled landscape fabric on seedlings for more than 1-2 weeks. When choosing to reinstall the landscape fabric, be cognizant of weather conditions that can cause fungus, as fungus can reduce success rates.

To reinstall the landscape fabric, use a metal or rubber ring 11 with a diameter that is slightly larger than the planting pot hole. The user can refer to section In-Ground Container. Cover the planting pot with the landscape fabric. Apply ring 11 to the fabric. Ensure the ring is on the outside of the planting pot. Insert landscape fabric pins 13 to secure the ring. Ensure landscape pins are fully inserted in to the ground and ensure the landscape fabric covers the seedlings uniformly to aid in uniform water dripping during rains and watering. After 1-2 weeks, remove the landscape fabric and give the seedlings a deep watering with a liquid fertilizer (3-1-2 ratio or similar).

19. As with any new grass, do not allow the soil to dry out, especially during hot and dry periods.

### Planting Pots for Plug Growing

This section is used for growing zoysia germinator super plugs. Non-biodegradable planter pots are used for seed germination and grass maturing. The size of the planter pot is up to the user. Planting pots with diameters of 4-12 inches work well. The smaller sizes in the range are good for ease of handling, but the larger sizes in the range make excellent giant zoysia plugs.

The mature grass is later removed from the planting pots and transplanted. Since this method will transplant the plugs at a later time, there will be transplant shock as with other commercially available plugs. Plastic reusable planter pots work well since plastic is bendable which helps loosen the plant from the container when ready to transplant in to the ground. This assembly method is similar to Biodegradable Planting Pots, and therefore sequenced immediately after the biodegradable planting pot section.

Items needed:
Round Non-Biodegradable planting pots
Quality topsoil with pH range of 6.0-6.5
Gray landscape fabric
Clear plastic (˜1 ml)
Rubber band, sized to seal fabric and plastic around planting pot
Quality Zenith or Japonica Zoysia seed
Hose with mist and shower setting
Dry topsoil (optional)

Steps:

1. Check the moisture content of the topsoil to be used to fill the planting pots. The moisture level of the topsoil is important so that sufficient moisture is available for seed germination. However, do not over saturate the mix. The soil should not be muddy. The soil can clump when squeezed, but should not clump on its own. The topsoil should not contain wood chips, stones, pebbles or other debris. The seeds should have a clean growing medium so they do not need to push through debris when germinating.

2. Cut the landscape fabric 1 and plastic 2 so that both will hang approximately ¼ to ½ way down the side of the planting pot.

3. Fill the planting pots approximately ⅔ with topsoil.

4. Using a cylinder or dowel 5, tamp down the soil 6 in the center of the planting pot using motion 7. One tamp is all that is required. The idea is to pre-settle soil at the center of the container so that there is not a depression in the center after settling.

5. Fill the remainder of the planting pot with topsoil. A slight crown to the soil is preferred, but minimally, ensure the soil is level with no depressions. Water should not pool in soil, either with initial planting or post germination.

6. Mist the surface of the topsoil.

7. Add seed as per its recommended rate to the topsoil in the planting pot. Spray seeds with a light mist of water or liquid fertilizer (3-1-2 ratio or similar).

8. At this point in the process, there are two options for ensuring good seed/soil contact. One option is to apply light pressure to the plastic that covers the seeds. The 2nd option is to lightly cover the seeds with dry topsoil, and then give the dry topsoil a good mist. If dry topsoil sprinkling is chosen, skip step 10.

9. Cover the planting pot with the clear plastic.

10. Apply light pressure to the plastic to provide good contact of the seed to the soil.

11. Cover the plastic with the gray landscape fabric. Ensure the plastic and fabric over hang approximately ¼ to halfway down the planting pot.

12. Attach rubber band 4 to the overhanging plastic and fabric. The rubber band should be snug to seal in the soil. The rubber band should be near the top of the planting pot, or at least the top half of the planting pot to ensure a good seal.

13. After approximately 10 days, check for germination by slightly removing one side of the plastic and fabric. Slightly remove the rubber band to accomplish this. Germination depends on weather conditions. The seeds will germinate faster during sunny day periods as compared with cloudy periods. Water the zoysia to keep the soil moist.

14. The gray landscape fabric can be optionally reinstalled over the planting pot. Reinstalling the landscape fabric will help keep the seedlings moist and will reduce watering needs. Spray the landscape fabric to keep the soil moist. Watering frequency depends on weather conditions. Watering once in the morning is a good guideline. Two watering's per day might be needed in especially hot and dry conditions. The water will drip through the fabric down to the seedlings. Another advantage of reinstalling the gray landscape fabric is if the planting pots are installed later in the summer season when 60 days of seedling establishment is cutting it close. The landscape fabric will protect the seedlings from frost. It is not recommended to keep the reinstalled landscape fabric on seedlings for more than 1-2 weeks. When choosing to reinstall the landscape fabric, be cognizant of weather conditions that can cause fungus, as fungus can reduce success rates. After 1-2 weeks, remove the landscape fabric and give the seedlings a deep watering with a liquid fertilizer (3-1-2 ratio or similar).

15. As with any new grass, do not allow the soil to dry out, especially during hot and dry periods.

### Optional Fabric and plastic Layering Method

The previous sections of Biodegradable Planting Pots and Planting Pots for Plug Growing, used a layering method of clear plastic over the soil and seeds, then landscape fabric layered on top of the plastic. The fabric and plastic are attached to the planting pot using a rubber band. This method does an efficient job of sealing in moisture to allow for ‘no touch’ seed germination.

An optional method can be used that first layer's landscape fabric, which is cut to the top inside diameter of the planting pot 8. Then clear plastic layered on top of the landscape fabric 9. The clear plastic extends halfway down the planting pot 10 and is attached with a rubber band as in 4.

This method is sometimes easier but comes with a caveat that it can cause the soil to lose moisture in especially hot and dry conditions since only the plastic layer is sealed against the planting pot.

### In-Ground Container

This section is used for In-Ground container seed germination. This method uses the ground as the planting container. This auto grow zoysia germinator is assembled directly in the ground. No planting pot is required. The seed will germinate in-ground where the roots are pre-acclimated to their surroundings.

Items needed:
Quality topsoil with pH range of 6.0-6.5
Gray landscape fabric
Clear plastic (˜1 ml)
Landscape fabric pins, 6-8 inch (galvanized preferred).
Purchase rings or make your own rings. The rings are used to seal in moisture. Most metal rings, macramé rings for example, work well for sealing in moisture. Other materials that can be used to make rings include solid electrical wire, garden hose, or similar material or plastic rings that will not easily crack.
Quality Zenith or Japonica Zoysia seed
Hose with mist and shower setting
Dry topsoil (optional)
For in-ground containers, the container and ring can be round, but does not need to be circular in shape. Any size or shape in-ground container can be used. The ring must be the same shape as the in-ground container so that the ring will seal in soil moisture.

Steps:

1. Purchase or make rings. The diameter of the planter ring is up to the user. The ring diameter 11 should be slightly larger than the diameter of the hole used for the in-ground planting container 12. This will allow the fabric pins 13 to be inserted in solid ground outside of the planting area so that seeds and soil do not get disturbed.

2. Cut the plastic and landscape fabric 14 to a larger diameter than the rings. Four inches larger is a good guideline. This will allow the plastic and fabric to extend 2 inches outside the ring for better moisture retention.

3. Check the moisture content of the topsoil to be used to fill the in-ground planting container. The moisture level of the topsoil is important so that sufficient moisture is available for seed germination. However, do not over saturate the mix. The soil should not be muddy. The soil can clump when squeezed, but should not clump on its own. The topsoil should not contain wood chips, stones, pebbles or other debris. The seeds should have a clean growing medium so they do not need to push through debris when trying to germinate.

4. Using an auger or a shovel, dig one hole for each in-ground planting container. The hole should be 4-5 inches deep. The in-ground container diameter should be slightly smaller than the ring diameter.

5. Fill the hole with moist topsoil. It is recommended to slightly crown the soil so that a depression does not form in the center of the planter. A depression in the topsoil will cause water to pool which can reduce success rates.

6. Add seed to the topsoil as per its recommended rate. Spray seeds with a light mist of water or liquid fertilizer (3-1-2 ratio or similar).

7. At this point in the process, there are two options for ensuring good seed/soil contact. One option is to apply light pressure to the plastic that covers the seeds. The 2nd option is to lightly cover the seeds with dry topsoil, and then give the dry topsoil a good mist. If dry topsoil sprinkling is chosen, skip step 9.

8. Cover the planting pot with the clear plastic.

9. Apply light pressure to the plastic to provide good contact of the seed to the soil.

10. Cover the clear plastic with the gray landscape fabric.

11. Center the ring over the fabric and ensure the ring only lays on existing soil or grass 15. Also ensure the plastic and fabric extend approximately 2 inches outside of the ring.

12. Insert landscape pins on to the ring to seal in moisture and anchor the ring. Ensure the landscape pins are fully inserted so they are in full contact with the ring and the landscape fabric so the pins or ring are not loosened by wind or a lawn mower passing over. The plastic and fabric inside the ring should be uniformly taught.

13. The Auto Grow Zoysia Germinators should not be stepped on or ridden over with lawn mower tires. The Auto Grow Zoysia Germinators should be installed in particular patterns so that lawn mowing can be easily accomplished without the lawn mower wheels running over the planters.

14. After approximately 10 days, check for germination by slightly removing one side of the plastic and fabric. You will need to remove one or two of the landscape pins to accomplish this. Germination depends on weather conditions. The seeds will germinate faster during sunny periods as compared with cloudy periods.

15. After the seedlings are approximately ½ inch high, remove the landscape pins, ring, fabric and plastic. Give the seedlings a deep watering with liquid fertilizer (3-1-2 ratio or similar). Water the seedlings 1-2 times per day depending on weather conditions. A garden hose with its nozzle set on the shower setting is a good watering method. Do not let the soil dry out

16. The gray landscape fabric can be optionally reinstalled over the in-ground planter. Reinstalling the landscape fabric will help keep the seedlings moist and will reduce watering needs. Spray the landscape fabric to keep the soil moist. Watering frequency depends on weather conditions. Watering once in the morning is a good guideline. Two watering's per day might be needed in especially hot and dry conditions. The water will drip through the fabric down to the seedlings. Another advantage of reinstalling the gray landscape fabric is if the planting pots are installed later in the summer season when 60 days of seedling establishment is cutting it close. The landscape fabric will protect the seedlings from frost. It is not recommended to keep the reinstalled landscape fabric on seedlings for more than 1-2 weeks. When choosing to reinstall the landscape fabric, be cognizant of weather conditions that can cause fungus, as fungus can reduce success rates.
To reinstall the landscape fabric, use the ring and fabric pins previously used. Insert landscape fabric pins to secure the ring. Ensure landscape pins are fully inserted in to the ground and ensure the landscape fabric covers the seedlings uniformly to aid in uniform water dripping during rains and watering.

17. As with any new grass, do not allow the soil to dry out, especially during hot and dry periods.

### In-Ground Tiller Planters

The following method creates an In-Ground planting bed using a rototiller. As with the In-Ground Container method, the In-Ground Tiller Planter uses the ground as the planting container. No planting pot is required. The seed will germinate in-ground where the roots are pre-acclimated to their surroundings.

Items needed:
Quality topsoil with pH range of 6.0-6.5
Gray landscape fabric
Clear plastic (˜1 ml)
Landscape fabric pins, 6-8 inch (galvanized preferred).
Rototiller (battery operated or gas)
Push mower or self-propelled lawn mower (battery operated or gas)
Garden rake
Tiller bed sealer material—flexible rubber or metal such as garden hose or solid electrical wire.
Quality Zenith or Japonica Zoysia seed
Hose with mist and shower setting
Dry topsoil (optional)

Steps:

1. Identify tiller planter locations 16. Ensure there are no rocks or other objects located at the tiller planter locations. Also, it is recommended to not create tiller planters where a large number of ant hills exist. The ants will re-excavate (dry) ant hills over the seed which can reduce germination success rates.

2. Ensure the ground is not dry. If the ground is dry, water the area with 1-2 inches of water, depending on dryness.

3. Cut the plastic 17 and landscape fabric 18 to a square or rectangle. The width should be the cutting width of the push mower. The length is up to the user, but lengths similar to or slightly longer than the mower cutting width allow for manageable sized tiller planters. The width and length of the tiller planter is ultimately up to the user.

4. Check the moisture content of the topsoil to be used. The topsoil will be used to top off the tiller planting bed. The moisture level of the topsoil is important so that sufficient moisture is available for seed germination. However, do not over saturate the mix. The soil should not be muddy. The soil can clump when squeezed, but should not clump on its own. The topsoil should not contain wood chips, stones, pebbles or other debris. The seeds should have a clean growing medium so they do not need to push through debris when germinating.

5. Set the mower blade to a low cutting level. Cut the grass using the mower to cut out the shape of the tiller planter.

6. Rototill the planting bed. The existing grass will till into the lawn soil. Till down 5-6 inches. For most of the existing grass, the tiller should grind and break up the grass and its roots into a compost like soil mixture. Using the mower cut in as a guide, leave approximately two inches of untilled soil around the circumference of the mower cut in. This will provide solid ground for the landscape pins.

7. Rake the top couple of inches of tilled soil to expose any clumps of grass that did not get broken up by the tiller. Remove any clumps of grass and weeds. Discard grass clumps and weeds into a bucket.

8. Optionally, fertilizer, such as 10-10-10 can be tilled in the soil.

9. Using the discard level of the bucket, add the approximately the same amount of topsoil to the tiller planter. Then, add additional topsoil to create a slight crown to the bed.

10. Add seed as per its recommended rate to the topsoil. Spray seeds with a light mist of water or liquid fertilizer (3-1-2 ratio or similar).

11. At this point in the process, there are two options for ensuring good seed/soil contact. One option is to apply light pressure to the plastic that covers the seeds. The 2nd option is to lightly cover the seeds with dry topsoil, and then give the dry topsoil a good mist. If dry topsoil sprinkling is chosen, skip step 13.

12. Cover the tiller planter with the clear plastic.

13. Apply light pressure to the plastic to provide good contact of the seed to the soil.

14. Cover the clear plastic with the gray landscape fabric.

15. Run the sealer material around the circumference of the tiller planter over the plastic and fabric. Ensure the plastic and fabric extend approximately 2 inches outside of the sealer material. Insert landscape fabric pins to anchor the sealer material. The number of pins needed depends on the ground contour but 8 pins per tiller planter is a good guideline. A pin in each corner and a pin midway between each corner is a good starting point. The weight and flexibility of the sealer material should aid in a good seal. Add pins when necessary to ensure a good seal to the fabric and plastic. The plastic and fabric should be uniformly taught.

16. The tiller planters should not be stepped on or ridden over with lawn mower tires. The tiller planters should be installed in particular patterns so that lawn mowing can be easily accomplished without the lawn mower wheels running over the planters.

17. After approximately 10 days, check for germination by slightly removing one side of the plastic and fabric. Remove a couple of the landscape pins to accomplish this. Germination depends on weather conditions. The seeds will germinate faster during sunny periods as compared with cloudy periods.

18. After the seedlings are approximately ½ inch high, remove the landscape pins, sealer, fabric and plastic. Give the seedlings a deep watering with liquid fertilizer (3-1-2 ratio or similar).

19. Water the seedlings 1-2 times per day depending on weather conditions. A garden hose with its nozzle set on the shower setting is a good watering method. Do not let the soil dry out.

20. The gray landscape fabric can be optionally reinstalled over the tiller planter. Reinstalling the landscape fabric will help keep the seedlings moist and will reduce watering needs. Spray the landscape fabric to keep the soil moist. Watering frequency depends on weather conditions. Watering once in the morning is a good guideline. Two watering's per day might be needed in especially hot and dry conditions. The water will drip through the fabric down to the seedlings. Another advantage of reinstalling the gray landscape fabric is if the planting pots are installed later in the summer season when 60 days of seedling establishment is cutting it close. The landscape fabric will protect the seedlings from frost. It is not recommended to keep the reinstalled landscape fabric on seedlings for more than 1-2 weeks. When choosing to reinstall the landscape fabric, be cognizant of weather conditions that can cause fungus, as fungus can reduce success rates.
To reinstall the landscape fabric, use the tiller sealer and fabric pins. Ensure landscape pins are fully inserted in to the ground and ensure the landscape fabric covers the seedlings uniformly to aid in uniform water dripping during rains and watering.

21. As with any new grass, do not allow the soil to dry out, especially during hot and dry periods.

1. A method for self-germinating zoysia grass seeds by layering clear plastic and gray landscape fabric over moistened, seeded topsoil and sealing in moisture for set it once, no watering seed germination, comprising the steps of:
a) Filling a planting container with moistened topsoil, the topsoil is crowned to prevent pooling of water, adding zoysia seed to the moistened topsoil, misting the zoysia seed, covering zoysia seed with clear plastic, applying light pressure to the clear plastic to ensure good seed to soil contact, covering the clear plastic with gray landscape fabric, sealing the clear plastic and gray landscape fabric.
Wherein; the planting container is a biodegradable planting pot.
Wherein; the clear plastic and gray landscape fabric hangs halfway down the planting pot and sealed using a rubber band attached to the outside of the planting pot.
Wherein; the biodegradable planting pot is installed in the ground with the seed level slightly higher than the surrounding earth.
Wherein; the planting container is a plastic, non-biodegradable planting pot.
Wherein; the clear plastic and gray landscape fabric hangs halfway down the planting pot and sealed using a rubber band attached to the outside of the planting pot.
Wherein; the zoysia grass seed is allowed to germinate and mature in the plastic, non-biodegradable planting pot and is later installed in the ground with the grass level slightly higher than the surrounding earth.
Wherein; the planting container is a round hole excavated out of the earth.
Wherein; clear plastic and gray landscape fabric is 6 inches larger than the planting container.
Wherein; the clear plastic and gray landscape fabric is placed over the planting container.
Wherein; the planting container is sealed by placing a plastic, rubber or metal ring over the clear plastic and gray landscape fabric.
Wherein; the diameter of the plastic, rubber or metal ring is 4 inches larger than the planting container.
Wherein; the plastic, rubber or metal ring is secured against the clear plastic and gray landscape fabric using a minimum of 3 evenly spaced landscape fabric pins to seal in moisture.
Wherein; the landscape fabric pins are fully installed in untouched earth surrounding the planting container.
b) Filling a planting container with moistened topsoil, the topsoil is crowned to prevent pooling of water, adding zoysia seed to the moistened topsoil, misting the zoysia seed, covering zoysia seed with gray landscape fabric that is the inside diameter of the planting container at the top of the topsoil, applying light pressure to the gray landscape fabric to ensure good seed to soil contact, covering the gray landscape fabric with clear plastic that hangs halfway down the planting container and sealing the clear plastic.
Wherein; the planting container is a biodegradable planting pot.
Wherein; the clear plastic fabric hangs halfway down the planting pot and sealed using a rubber band attached to the outside of the planting pot.
Wherein; the biodegradable planting pot is installed in the ground with the seed level slightly higher than the surrounding earth.
Wherein; the planting container is a plastic, non-biodegradable planting pot.
Wherein; the clear plastic hangs halfway down the planting pot and sealed using a rubber band attached to the outside of the planting pot.
Wherein; the zoysia grass seed is allowed to germinate and mature in the plastic, non-biodegradable planting pot and is later installed in the ground with the grass level slightly higher than the surrounding earth.
c) Filling a planting container with moistened topsoil, the topsoil is crowned to prevent pooling of water, adding zoysia seed to the moistened topsoil, misting the zoysia seed, covering zoysia seed by sprinkling a thin layer of dry topsoil over the seed, moisten dry topsoil by misting, covering the moistened topsoil with clear plastic, covering the clear plastic with gray landscape fabric, sealing the clear plastic and gray landscape fabric:
Wherein; the planting container is a biodegradable planting pot.
Wherein; the clear plastic and gray landscape fabric hangs halfway down the planting pot and sealed using a rubber band attached to the outside of the planting pot.
Wherein; the biodegradable planting pot is installed in the ground with the seed level slightly higher than the surrounding earth.
Wherein; the planting container is a plastic, non-biodegradable planting pot.
Wherein; the clear plastic and gray landscape fabric hangs halfway down the planting pot and sealed using a rubber band attached to the outside of the planting pot.
Wherein; the zoysia grass seed is allowed to germinate and mature in the plastic, non-biodegradable planting pot and is later installed in the ground with the grass level slightly higher than the surrounding earth.
Wherein; the planting container is a round hole excavated out of the earth.
Wherein; clear plastic and gray landscape fabric is 6 inches larger than the planting container.
Wherein; the clear plastic and gray landscape fabric is placed over the planting container.
Wherein; the planting container is sealed by placing a plastic, rubber or metal ring over the clear plastic and gray landscape fabric.
Wherein; the diameter of the plastic, rubber or metal ring is 4 inches larger than the planting container.
Wherein; the plastic, rubber or metal ring is secured against the clear plastic and gray landscape fabric using 3 evenly spaced landscape fabric pins to seal in moisture.
Wherein; the landscape fabric pins are fully installed in untouched earth surrounding the planting container.
d) Making a planting container by tilling a square or rectangular section of lawn or ground, removing clumps of grass or weeds that were not broken up by tilling, augmenting planting container with moistened topsoil, crowning the soil level of the planting container with additional moistened topsoil to prevent pooling of water, adding zoysia seed to the moistened topsoil, misting the zoysia seed, covering zoysia seed by sprinkling a thin layer of dry topsoil over the seed, moisten dry topsoil by misting, covering the moistened topsoil with clear plastic, covering the clear plastic with gray landscape fabric, sealing the clear plastic and gray landscape fabric.
Wherein; the clear plastic and gray landscape fabric extends 2-3 inches past the planting container.
Wherein; the planting container is sealed using rubber material such as or similar to garden hose or electrical cable that is placed over the clear plastic and gray landscape fabric.
Wherein; the sealer material is secured using landscape fabric pins.
Wherein; a sufficient number of landscape fabric pins are used to seal in moisture.
Wherein; the landscape fabric pins are fully installed in untouched earth surrounding the planting container.
